(19) United States
(12) Patent Application Publication
(10) Pub. No.: US 2021/0037845 A1
(43) Pub. Date: Feb. 11, 2021

(54) MOZZARELLA CHEESE

(71) Applicant: PRIMULA SOCIETA' SEMPLICE, Milano (IT)

(72) Inventors: Matteo Lavezzini, Fontanellato (Parma) (IT); Angelo Savino, Mezzanego (Genova) (IT)

(73) Assignee: PRIMULA SOCIETA' SEMPLICE, Milano (IT)

(21) Appl. No.: 16/963,863

(22) PCT Filed: Jan. 22, 2019
(86) PCT No.: PCT/IB2019/050524

§ 371 Date: Jul. 22, 2020

(30) Foreign Application Priority Data
Jan. 22, 2018 (IT) 102018000001631

(51) Int. Cl. A23C 19/068; A23C 19/032; A23C 19/06; A23P 30/20; A01J 25/12; A01J 27/00

(52) U.S. Cl. CPC A23C 19/0684; A23C 19/0323; A23C 19/062; A23C 2250/10; A01J 25/12; A01J 27/00; A23P 30/20

(57) ABSTRACT

The object of the present invention is a mozzarella cheese obtained from a mixture of raw materials consisting of milk, rennet, salt and optionally lactic bacteria and having a high residual moisture content. Said mozzarella cheese can be obtained by means of a production method comprising a cooling step in air for cooling a sheet of mozzarella cheese.

### TECHNICAL FIELD OF THE INVENTION

The object of the present invention is a mozzarella cheese obtained from a mixture of raw materials consisting of milk, rennet, salt and optionally lactic bacteria and that has a high residual moisture content.

### STATE OF THE ART

To date, the mozzarella cheese used in pizzerias is obtained by making a substantially cylindrical log of mozzarella cheese. This log is usually obtained from a mozzarella cheese pasta filata that has been worked at a high temperature and from which a cylindrically-shaped log is obtained which is cooled by immersing it in water, possibly in brine.

Starting from milk, rennet, salt and fermenting agents, the mozzarella cheese obtained generally has a residual moisture content of about 49-53% by weight.

Moreover, given that the log cooling process takes place by immersion in water, the distribution of residual moisture in the mozzarella cheese is not homogeneous. The external part of the log of mozzarella cheese will thus prove to have more moisture than the internal part.

Mozzarellas with a higher residual moisture content can be obtained even with the known pasta filata cooling systems of the prior art, but this is normally done by adding processing aids, generally synthetic processing aids, to the raw materials indicated above.

Even if the residual moisture content of mozzarella cheese obtained with conventional methods is increased, the prior-art mozzarella cheese for pizza has a tendency to burn at the pizza baking temperatures used in pizzerias or in domestic ovens.

Furthermore, mozzarellas with a higher residual moisture content entail packaging problems when marketed in a ready-to-use form, for example in cubes. Due to the higher residual moisture content, the cut product tends to become compressed, making it impossible to package the product in large-sized packages, which are more suited to industrial distribution or to distribution to pizzerias.

In this context, the present invention has the primary task of providing a mozzarella cheese with a high residual moisture content, obtained starting only from raw materials of natural origin, and which does not burn at the pizza baking temperatures normally used in professional ovens (pizzerias) or in domestic ovens.

### SUMMARY OF THE INVENTION

The present invention concerns a mozzarella cheese obtained from a mixture of raw materials consisting of milk, rennet, salt and optionally lactic bacteria, wherein said mozzarella cheese has a residual water content of 55-60% by weight and comprises an amount of furosine of less than 12 mg per 100 g of a protein substance.

### DESCRIPTION OF THE FIGURES

FIG. 1 is a schematic illustration of a system for producing mozzarella cheese according to the invention.

### DETAILED DESCRIPTION OF THE INVENTION

In the context of the present invention, the percentages are understood as expressed by weight unless otherwise stated.

In the context of the present invention, the term “ambient pressure” refers to a pressure of about 101.32 kPA; the term “ambient temperature” refers to a temperature of about 20-30° C.

In the context of the present invention, the term “mozzarella cheese” indicates a fresh semi-cooked pasta filata cheese that is soft.

In the context of the present invention, the terms “residual water” and “residual moisture” are used as synonyms.

The present invention concerns a mozzarella cheese obtained from a mixture of raw materials consisting of milk, rennet, salt and optionally lactic bacteria, wherein said mozzarella cheese has a residual water content of 55-60% by weight and comprises an amount of furosine of less than 12 mg per 100 g of a protein substance.

The milk can be selected from among cow's milk, buffalo milk, goat's milk, sheep's milk and mixtures thereof, preferably from among cow's milk, buffalo milk and mixtures thereof, and more preferably the milk is cow's milk.

The rennet can be of animal origin, that is, obtained from the stomach of an unweaned ruminant and it can be used in a powdered or liquid form, if first dispersed in water, or the rennet can be of microbial origin, that is, extracted from bacteria or moulds, possibly specifically selected for this purpose. Preferably, the mozzarella cheese according to the invention can be obtained using animal rennet.

Optionally, but preferably, the mozzarella cheese of the invention can be obtained from a mixture in which lactic bacteria have been added to enrich the mozzarella cheese with dairy microflora. These lactic bacteria may belong to at least one genus selected from among Lactobacillus, Lactococcus, Leuconostoc, Streptococcus and Pediococcus, and preferably belong to at least one genus selected from among Lactobacillus and Streptococcus.

The lactic bacteria can be added to the mixture in the form of selected “starter” cultures, which are found on the market in the form of mother cultures for direct or semi-direct inoculation. Alternatively, the lactic bacteria can be autochthonous, that is, (self-) produced from milk or whey coming from the same agricultural area as the milk used to produce the mozzarella cheese.

The mozzarella cheese according to the invention has a residual water content of about 55-60% by weight with respect to the total weight of the mozzarella cheese. The residual water (or moisture) content can be determined by means of the method specified in UNI EN ISO 5534/2004.

Moreover, the mozzarella cheese according to the invention comprises an amount of furosine of less than 12 mg per 100 g of a protein substance, preferably less than 10 mg per 100 g of a protein substance, and more preferably less than 9 mg per 100 g of a protein substance, wherein the furosine content is determined as described herein below.

Furosine (or ε-furoyl methyl-lysine; CAS No: 19746-33-9) is a chemical compound that is not originally present in milk and that is produced as a result of heat treatment of milk.

The mozzarella cheese according to the invention has a high residual moisture content, comprised within the range indicated hereinabove. Furthermore, the residual moisture is uniformly distributed within the mass of cheese.

In particular, the residual moisture content of the mozzarella cheese according to the invention can be uniform when measured in various points of a cylinder of mozzarella having a diameter of 75-110 mm and a height greater than or equal to 10 mm. The term “uniform” is used in this context to indicate that the percentage change in residual moisture between the various points of the cylinder of mozzarella described above is less than or equal to 1% by weight.

The mozzarella cheese according to the invention can preferably be produced using a method that comprises the steps of:

(a) preparing a curd obtained from a mixture of raw materials consisting of milk, rennet, salt and optionally lactic bacteria;

(b) breaking up, kneading and stretching the curd at a temperature higher than or equal to 80° C., thereby obtaining a pasta filata;

(c) extruding the pasta filata, thereby obtaining a sheet of mozzarella cheese of a thickness greater than or equal to 3 mm, preferably of a thickness of 3-75 mm;

(d) cooling the sheet of mozzarella cheese in an air-cooling tunnel;

(e) cutting or shaping the sheet of mozzarella cheese.

The curd of step (a) can be produced using methods and equipment known to a person skilled in the art and therefore they are not described further herein. The coagulation of the milk can be a quick process (even in less than 10 minutes) or a long process (several hours) depending on the amounts of rennet added, the temperature to which the milk is brought, the bacterial flora and the fats present in the milk.

Once a suitable acidity has been achieved, the curd of step (a) is broken up, kneaded and stretched in step (b) (the so-called “spinning” process). This step can be implemented using methods and equipment normally employed for the spinning process in water, that is, by immersing the curd in water at a temperature of about 80-90° C. Alternatively, the spinning process can be carried out in a steam stretcher, in which the curd is broken up, kneaded and stretched, while heating it by means of direct injection of steam at a temperature of about 130° C. Irrespective of which spinning technique is used, the pasta filata that is obtained at the end of the spinning step is at a high temperature.

In step (c) the pasta filata is extruded through an extrusion means which makes it possible to obtain a sheet of mozzarella cheese of a thickness greater than or equal to 3 mm, preferably of a thickness of 3-75 mm. In the context of the present invention, the term “sheet of mozzarella cheese” refers to a layer of mozzarella cheese that extends substantially parallel to a surface, the layer having a substantially two-dimensional extension, that is, a layer the thickness of which is significantly smaller than its length and its width. In one form of implementation, the thickness of the sheet of mozzarella cheese obtained in step (c) can be equal to about 3-6 mm.

In a further form of implementation, the mozzarella cheese according to the invention can be obtained by means of a method in which step (c) comprises the substeps of:

(c) extruding the pasta filata, thereby obtaining a sheet of mozzarella cheese having a first thickness greater than or equal to 13 mm, preferably of 13-75 mm;

(c2) reducing said first thickness to values of 3 to 6 mm by compression.

In one form of implementation, the sheet of mozzarella cheese in step (c) can have a water content of about 55-60% by weight.

At the end of the extrusion step, the sheet of mozzarella cheese is still at a considerably high temperature, generally higher than 45° C.

Therefore, in step (d) the sheet of mozzarella cheese is cooled in an air-cooling tunnel. The Applicant has surprisingly found that by cooling a sheet of mozzarella cheese in an air tunnel instead of by immersion in cold water according to known prior-art methods, it is possible to obtain a mozzarella cheese that has a high water content starting only from the raw materials indicated in step (a) and in which the residual moisture is distributed uniformly in the mass of mozzarella cheese.

In the cooling tunnel, the air, which has a lower temperature with respect to the temperature of the sheet of mozzarella cheese, cools the product by natural or forced air convection. The reduced thickness and the ample surface of the sheet of mozzarella cheese facilitate heat exchange and heat removal, making the air-cooling step (d) more efficient compared to a conventional step of cooling by immersion in water.

In one form of implementation, the mozzarella cheese according to the invention can be obtained by means of a method in which step (d) comprises the substeps of:

(d1) arranging a cooling tunnel comprising at least one feed belt, which is optionally perforated;

(d2) positioning the sheet of mozzarella cheese on the at least one feed belt;

(d3) having the sheet of mozzarella cheese travel inside the cooling tunnel, cooling the sheet by natural or forced air convection.

At the end of step (d), the sheet of mozzarella cheese is cooled down to ambient temperature and it can be suitably cut or shaped in the subsequent step (e). The mozzarella cheese according to the invention can be obtained by means of a method in which step (e) comprises cutting the sheet of mozzarella cheese with cutting blades, preferably with rotating blades, or punching the sheet of mozzarella cheese with a shaped cutter so as to obtain pieces of mozzarella cheese that are counter-shaped with respect to the perimeter of the shaped cutter. Mozzarella cheese of the desired shape can thus be obtained, for example in the shape of a log or in cubes, julienne strips, etc. In one form of implementation, the mozzarella cheese according to the invention has the shape of a parallelepiped, in which the length of the longest edges is equal to about 3-75 mm and the length of the remaining edges is equal to about 3-6 mm.

Moreover, when produced using the method described above, in which the mozzarella cheese is cut with rotating blades in step (e), the final product obtained does not have leftover scraps on the surface.

At the end of step (e) the mozzarella cheese according to the present invention is directed to the product packaging line. The method described above can optionally and preferably comprise a step (f) of packaging the mozzarella cheese. When the mozzarella cheese according to the invention is packaged in packages comprising a multitude of pieces, the packaging step can comprises a step of weighing and measuring out the pieces of mozzarella cheese.

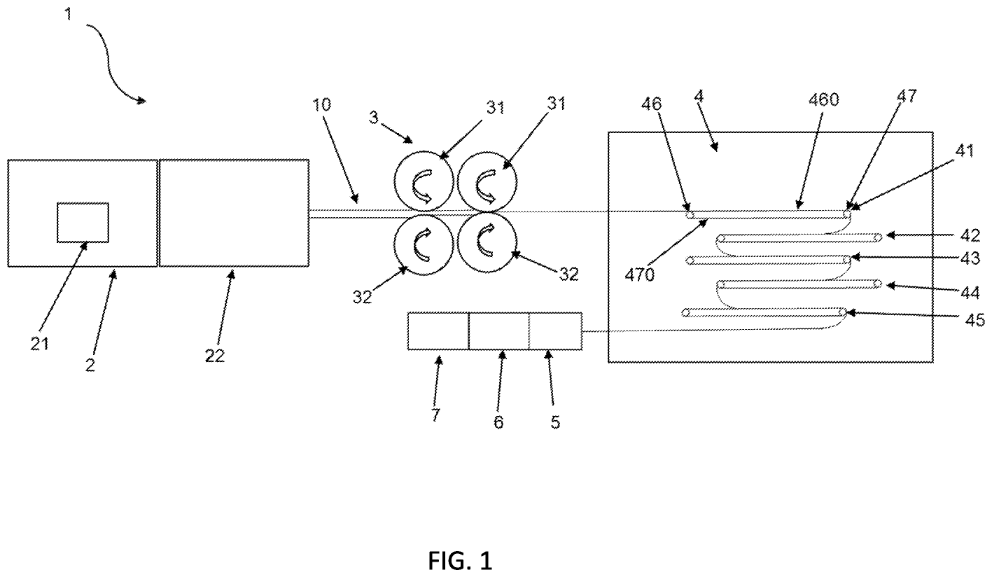

FIG. 1 is a schematic illustration of a system 1 that can be employed for the production of mozzarella cheese according to the invention, particularly for the production of mozzarella cheese cut into small pieces, of the type normally used in pizzerias.

The system 1 comprises a stretcher 2 comprising a heating means 21 for heating the curd. Downstream of the stretcher 2, the system 1 comprises an extrusion means 22 which makes it possible to shape a sheet of mozzarella cheese. Conveniently, downstream of the shaping means 22, the system 1 comprises an adjustment station 3 comprising counter-rotating rollers 31 and 32 that reduce the thickness of the sheet passing between them. Downstream of the adjustment station 3, the system 1 further comprises an air-cooling tunnel 4. The air present in the cooling tunnel 4 is cooled and in turn cools the sheet by natural or forced air convection. Downstream of the cooling tunnel 4, the system 1 further comprises a station 5 for shaping or cutting pieces of mozzarella cheese.

The shaping station 5 can comprise a cutting means that punches the sheet, thereby forming pieces of mozzarella cheese that have a predefined shape. Alternatively, the cutting station 5 can comprise cutting blades, possibly rotating blades. Optionally, but preferably, downstream of the shaping or cutting station 5, the system 1 can comprise a weighing station 6 for weighing pieces of mozzarella cheese and a packaging station 7 for packaging the mozzarella cheese.

The curd is placed in the stretcher 2, preferably a steam stretcher, in which it is broken up, kneaded and stretched and subsequently extruded, thus making a sheet 10 of mozzarella cheese. The sheet 10 of mozzarella cheese is optionally, but preferably extruded with a first thickness greater than or equal to about 13 mm, preferably with a thickness of about 13-75 mm. The sheet 10 of mozzarella cheese is advanced along the processing line and subsequently the thickness of the sheet 10 of mozzarella cheese is advantageously reduced by compression in the adjustment station by means of the counter-rotating nip rollers 31 and 32. The thickness of the sheet of mozzarella cheese can thus be reduced to about 3-6 mm.

The cooling step (d) comprises having the sheet of mozzarella cheese move into the air-cooling tunnel 4, positioning the sheet on at least one feed belt, which is optionally perforated. Advantageously, the sheet of mozzarella cheese can be moved forward on a set 41, 42, 43, 44, 45 of feed belts located one above the other and that travel through the cooling tunnel 4. Each one of said belts defines an upper stroke 460 and a lower stroke 470 between two corresponding end rollers 46 and 47. The sheet of mozzarella cheese advances as it is conveyed by the belt along the upper stroke 460, whereas at the beginning of the lower stroke 470, it will come off the belt by virtue of gravity and rest on the underlying belt, which advantageously moves in an opposite direction with respect to the overlying belt (if one is clockwise the other is counter-clockwise). The process of laying the sheet of mozzarella down on the underlying belt by virtue of gravity brings about the overturning of the sheet. After it is overturned and resting on the lower belt, the surface of the sheet which was facing downwards on the overlying belt will be facing upwards.

At the exit from the cooling tunnel 4, the sheet of mozzarella cheese will be at ambient temperature.

The sheet of mozzarella cheese is cut or shaped in the shaping station 5. The shaping station 5 is preferably a cutting station comprising two sets of counter-rotating blades.

Optionally, the mozzarella cheese cut into pieces can be weighed in the weighing station 6 and packaged in the packaging station 7.

Owing to the high residual water content and to its uniform distribution in the mass of cheese, the advantage of the mozzarella cheese according to the present invention is that it does not burn when baked at pizza baking temperatures, which typically range between about 250° C. (electric oven) and about 490° C. (wood-fired oven).

Moreover, when cut into pieces and packaged in packages comprising a multitude of said pieces, the mozzarella cheese according to the invention does not have the tendency to become compressed. Therefore, large amounts of mozzarella cheese can be packaged even when the cheese is cut up into small pieces, without using release agents. For example, bags of pieces of mozzarella cheese can be packaged and have a final weight of about 5 Kg, without the mozzarella cheese cut into pieces becoming compressed. This represents an advantage not only economically, but also in terms of nutrition, as well as in terms of the environmental impact of the product, which will generate less packaging waste as it is packaged in larger packages.

Moreover, the mozzarella cheese according to the invention has a longer shelf life than mozzarella cheese obtained by means of production methods that comprise a cooling step in water. The Applicant has surprisingly found that the shelf life of the mozzarella cheese according to the invention can be longer than or equal to 35 days, preferably longer than or equal to 40 days, and more preferably longer than or equal to 52 days after production. Furthermore, the shelf life of the mozzarella cheese of the invention can be shorter than or equal to 65 days, preferably shorter than or equal to 62 days.

Method for Determining the Furosine Present in the Mozzarella Cheese.

The amount of furosine present in the mozzarella cheese according to the invention is determined by means of ion-pair reversed-phase HPLC with detection at 280 nm. Quantification is carried out by external standardization with synthetic furosine.

In a 10-ml Pyrex test tube provided with a screw cap that has a Teflon gasket or another hermetic sealing system that is heat-resistant, weigh an amount of mozzarella cheese corresponding to about 50 mg of protein and add 8 ml of 8 N hydrochloric acid. Bubble nitrogen in the test tube for about 2 minutes. Tightly close the test tube and place it in the oven at 110° C. for 23 hours. Agitate the test tube after the first hour of hydrolysis. Filter the hydrolysate on a filter paper with medium filtration velocity. Determine the total nitrogen content by the Kjeldahl method in 2 ml of the filtrate and calculate the protein content by multiplying by 6.38.

Insert a C18 500-mg solid-phase extraction cartridge on a 5-ml glass syringe. Activate the cartridge, eluting 5 ml of methanol and 10 ml of distilled water in succession, preventing the cartridge from drying out between one step and another. Pipette 0.5 ml of the filtrate into the syringe and slowly inject it into the cartridge, discarding the corresponding eluate, but preventing air from entering the cartridge. Pipette 3 ml of HCl 3 N into the syringe and slowly elute until the cartridge is completely dried up, collecting the eluate (purified filtrate) which must be colourless. Agitate and store the purified filtrate at low temperature; it remains stable at −20° C. for one week.

A chromatograph with a biocompatible injector, provided with a 20- or 50-μl loop and a column thermostating oven, can be used for the high performance liquid chromatography procedure. A C8 reversed-phase column that makes it possible to elute the furosine separated on the baseline and without interference from other peaks.

A spectrophotometer for continuous detection at 28 nm, with a sensitivity of at least 0.010 AUFS. Under the chromatographic conditions indicated and with a 20-μl injection loop, the signal-to-disturbance ratio, which is detectable for a peak corresponding to 10 picomoles of injected synthetic furosine, must be no less than 10.

Prepare a standard solution of furosine: from chromatographically pure synthetic furosine having a known titre, prepare a solution in 3 N hydrochloric acid that contains about 1 nmole of furosine per ml. This solution is stable at −20° C.

Chromatographic Conditions:

Eluent A: 0.4% of acetic acid in water (v/v).

Eluent B: 0.3% potassium chloride in eluent A (w/v).

Elution gradient(*)

| time (min) | % A | % B |
|---|---|---|
| 0 | 100 | 0 |
| 13.5 | 100 | 0 |
| 20.5 | 50 | 50 |
| 22.0 | 50 | 50 |
| 23.0 | 100 | 0 |
| 32.0 | 100 | 0 |

(*)or equivalent, as a function of the column used.

Flow rate: 1.2 ml/min.

Temperature of the column: at a constant temperature ranging between 30 and 35° as a function of the column used.

Equilibrate the column for several minutes at 1.2 ml/min. with a solution A:B=50:50. Then bring the chromatographic system back to the initial analysis conditions until the baseline is stable. Perform a complete chromatographic run, injecting 20 μl of 3 N hydrochloric acid to check the purity of the eluents. Following final equilibrium, the baseline value should return to its initial value.

Carry out the chromatographic separation of the purified filtrate and then the chromatographic separation of the standard solution of furosine. The separation of the peak of furosine must take place on the baseline and with a retention time ranging between 21 and 24 minutes. Integrate the furosine peak area obtained for the purified filtrate of the sample and for the standard solution, on the baseline.

The amount of furosine in the sample, expressed in mg per 100 g of proteins, is calculated as follows:

$$Ac \times \frac{Cs}{As} \times \frac{1}{v} \times \frac{6}{0 , 95} \times \frac{254}{10} \times \frac{8}{m \times 4}$$

where:

Ac=peak area of furosine in the sample

Cs=amount of injected standard furosine, in picomoles

As=peak area of furosine in the standard

v=injection loop volume, in (Micron(I

6=dilution factor resulting from solid phase extraction

0.95=furosine recovery factor resulting from solid-phase extraction

254=molecular weight of furosine

m=protein content of 2 ml of hydrolysate, in mg, determined as reported hereinabove.

1. A mozzarella cheese obtained from a mixture of raw materials consisting of milk, rennet, salt and optionally lactic bacteria, wherein said mozzarella cheese has a residual water content of 55-60% by weight and comprises an amount of furosine of less than 12 mg per 100 g of a protein substance.

2. The mozzarella cheese according to claim 1, wherein the milk is selected from among cow's milk, buffalo milk, goat's milk, sheep's milk and mixtures thereof, buffalo milk and mixtures thereof.

3. The mozzarella cheese according to claim 1, wherein the lactic bacteria belong to at least one genus selected from among Lactobacillus, Lactococcus, Leuconostoc, Streptococcus and Pediococcus.

4. The mozzarella cheese according to claim 1, wherein the moisture content measured in different points of a cylinder of mozzarella having a diameter of 75-110 mm and a height greater than or equal to 10 mm is uniform.

5. The mozzarella cheese according to claim 1, obtained by means of a method comprising the steps of:
(a) preparing a curd obtained from a mixture of raw materials consisting of milk, rennet, salt and optionally lactic bacteria;
(b) breaking up, kneading and stretching the curd at a temperature higher than or equal to 80° C., thereby obtaining a pasta filata;
(c) extruding the pasta filata, thereby obtaining a sheet of mozzarella cheese of a thickness equal to or greater than 3 mm;
(d) cooling the sheet of mozzarella cheese in an air-cooling tunnel;
(e) cutting or shaping the sheet of mozzarella cheese.

6. The mozzarella cheese according to claim 5, obtained by a method in which the sheet of mozzarella cheese in step (c) has a water content of 55-60% by weight.

7. The mozzarella cheese according to claim 5, obtained by a method in which step (c) comprises the substeps of:
(c1) extruding the pasta filata, thereby obtaining a sheet of mozzarella cheese having a first thickness greater than or equal to 13 mm, preferably of 13-75 mm;
(c2) reducing said first thickness to values of 3 to 6 mm by compression.

8. The mozzarella cheese according to claim 5, obtained by means of a method in which step (d) comprises the substeps of:
(d1) arranging a cooling tunnel comprising at least one feed belt, which is optionally perforated;
(d2) positioning the sheet of mozzarella cheese on the at least one feed belt;
(d3) having the sheet of mozzarella cheese travel inside the cooling tunnel, cooling the sheet by natural or forced air convection.

9. The mozzarella cheese according to claim 5, obtained by means of a method in which step (e) comprises cutting the sheet of mozzarella cheese with cutting blades, preferably with rotating blades, or punching the sheet of mozzarella cheese with a shaped cutter so as to obtain pieces of mozzarella cheese that are counter-shaped with respect to the perimeter of the shaped cutter.

10. The mozzarella cheese according to claim 1, wherein the mozzarella cheese has the shape of a parallelepiped, in which the length of the longest edges is of 3-75 mm and the length of the remaining edges is of 3-6 mm.

11. The mozzarella cheese according to claim 2, wherein the milk is cow's milk.

12. The mozzarella cheese according to claim 3, wherein the lactic bacteria belong to at least one genus selected from among Lactobacillus and Streptococcus.

13. The mozzarella cheese according to claim 5, wherein the sheet of mozzarella cheese has a thickness of 3-75 mm;

14. The mozzarella cheese according to claim 7, wherein the sheet of mozzarella cheese has a first thickness of 13-75 mm.

15. The mozzarella cheese according claim 9, wherein the cutting blades are rotating blades.
